(19) United States
(12) Patent Application Publication
(10) Pub. No.: US 2017/0169193 A1
(43) Pub. Date: Jun. 15, 2017

(54) VERIFIED PATIENT DATA COLLECTION SYSTEM

(71) Applicant: 9g Enterprises Inc., Springtown, TX (US)

(72) Inventor: Blake Robert Vosburgh, Boise, ID (US)

(21) Appl. No.: 15/373,187

(22) Filed: Dec. 8, 2016

Related U.S. Application Data
(60) Provisional application No. 62/266,244, filed on Dec. 11, 2015.

(51) Int. Cl. G06F 19/00; G06F 17/30

(52) U.S. Cl. CPC G06F 19/363; G06F 17/30867; G06Q 30/0282

(57) ABSTRACT

A verified patient data collection system configured to aggregate and provide verified patient feedback is presented. The verified patient data collection system comprises a data store comprising patient data and provider data. The verified patient data collection system also comprises a data processing system. The data processing system is configured to generate a patient survey to a verified patient, using survey generation logic. The data processing system is also configured to analyze a survey response from the verified patient, using response analyzer logic to generate the verified patient feedback. The verified patient data collection system also comprises a response data store configured to store the analyzed survey response, verified patient feedback, and a searchable response index. In response to a request for feedback, the data processing system is also configured to, using surfacing logic, search the response index and provide the verified patient feedback.

### CROSS-REFERENCE TO RELATED APPLICATIONS

The present application is based on and claims the benefit of U.S. Provisional Patent Application Ser. No. 62/266,244 filed Dec. 11, 2015, the content of which application is hereby incorporated by reference in its entirety.

### BACKGROUND

Handling of patient related information requires compliance with a number of government regulations in order to ensure proper patient care and to ensure patient privacy. One problem facing healthcare companies is the desire of prospective patients to know about their prospective practitioners (e.g. doctors, nurses, surgeons, etc.) and/or prospective healthcare providers (e.g. medical practice and their administrator, quality assurance, etc.) and facilities. In other industries, review sites may be available to provide information about prospective services or specific stores.

The discussion above is merely provided for general background information and is not intended to be used as an aid in determining the scope of the claimed subject matter.

### SUMMARY

A verified patient data collection system configured to aggregate and provide verified patient feedback is presented. The verified patient data collection system comprises a data store comprising patient data and provider data. The verified patient data collection system also comprises a data processing system. The data processing system is configured to generate a patient survey to a verified patient, using survey generation logic. The data processing system is also configured to analyze a survey response from the verified patient, using response analyzer logic to generate the verified patient feedback. The verified patient data collection system also comprises a response data store configured to store the analyzed survey response, verified patient feedback, and a searchable response index. In response to a request for feedback, the data processing system is also configured to, using surfacing logic, search the response index and provide the verified patient feedback.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 illustrates a network in accordance with one embodiment of the present invention.

FIG. 2 illustrates a block diagram of a verified data collection system in accordance with one embodiment of the present invention.

FIG. 3 illustrates a flow diagram of a method for obtaining verified feedback in accordance with one embodiment of the present invention.

FIG. 4 illustrates a flow diagram of a method of indexing patient response data in accordance with one embodiment of the present invention.

FIG. 5 illustrates a flow diagram of a method of displaying search results in accordance with one embodiment of the present invention.

FIG. 6 illustrates a flow diagram of a method of delivering verified patient survey results in accordance with one embodiment of the present invention.

FIGS. 7A and 7B illustrate exemplary user interfaces generated for a practitioner by a verified data collection system in accordance with one embodiment of the resent invention.

FIGS. 8A-8C illustrate user interfaces generated by a verified data collection system for a patient in accordance with one embodiment of the present invention.

FIG. 9 is a block diagram showing a mobile device that can be used in a cloud architecture in accordance with one embodiment of the present invention.

FIGS. 10-12 show examples of mobile devices.

FIG. 13 shows one example of a computing device that can be used in accordance with embodiments of the present invention.

While embodiments of the present invention are amenable to various modifications and alternative forms, specifics thereof have been shown by way of example in the drawings and will be described in detail below. It should be understood, however, that the intention is not to limit the invention to the particular embodiments described. On the contrary, the intention is to cover all modifications, equivalence, and alternatives falling within the spirit and scope of the invention.

### DETAILED DESCRIPTION OF THE DRAWINGS

Prospective patients want to be able to find information about prospective healthcare providers, healthcare facilities, and practitioners (e.g. doctors, CRNAs, nurses, surgeons, anesthesiologists, physician assistants, or any other individual responsible for all or a portion of a patient's care). Additionally, prospective patients often want feedback provided by actual former patients of a given provider, facility, and/or practitioner. However, the information should be at least one step removed from the healthcare professional facility themselves, as those institutions may have a bias towards their own healthcare offerings. Additionally, former patients may want to give feedback anonymously, such that they can state their opinions while maintaining their privacy. Therefore, a system provided by a third party may provide an opportunity for patients to give feedback on actual care received, such that prospective patients can better understand their provider, practitioner and procedure.

In some industries, review sites are available to provide information about prospective services or specific stores. For example, Yelp provides users with reviews of prospective dining options. However, false information not from actual patients in the medical industry, or those that did not engage services from a given practitioner, may damage that practitioner's reputation and/or mislead other prospective patients. Therefore, a system is desired that allows for actual, verified patients to provide feedback while maintaining their privacy.

Additionally, healthcare practitioners may also want feedback regarding the level of care they provide. It may be helpful for that feedback to be collected by a third party system, so that patients do not feel pressured to give positive feedback. At least some embodiments provided herein illustrate a system configured to generate feedback requests, aggregate responses, and present detailed feedback to requesting practitioners as well as prospective patients.

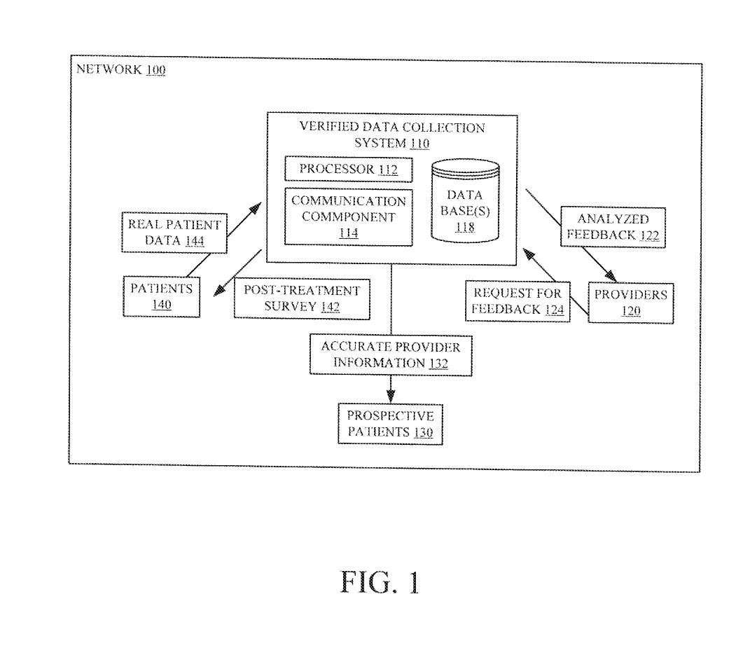

FIG. 1 illustrates a network in accordance with one embodiment of the present invention. In one embodiment, network 100 is implemented in a cloud-based architecture. Network 100, in one embodiment, comprises a verified data collection system 110. Verified data collection system 110, in one embodiment, is accessible by one or more providers (e.g. medical practice and their administrators, quality assurance personnel, etc.) and one or more patients. While FIG. 1 illustrates one or more providers 120 initiating a request, it is also to be understood that, in at least some embodiments, individual practitioners can also initiate independent requests, or obtain data resulting from a provider-initiated request. Verified data collection system 100 is also configured to provide information to prospective patients 130, upon request.

For example, during or after care, a provider, for example any of providers 120, may want feedback from one or more patients 140. For example, a provider may wish to illicit feedback about recovery time for a given procedure, the patient's experience with a specific practitioner—for example the doctor, the nurse, etc., as well as the patient's experience with the facility, their insurance, or any other information about their experience within the operation itself. Provider 120 may, then, utilize verified data collection system 100 in order to receive feedback from patients 140. The feedback from patients 140, in at least one embodiment, in anonymized such that providers 120 cannot see which patients 140 provided which specific feedback. The ability to provide anonymous results may encourage more patients 140 to provide feedback upon request.

Provider 120 may send a request for feedback 124 to verified data collection system 110. Verified data collection system 110 may, as part of the request for feedback 124, receive information regarding one or more patients 140 that have received care from provider 120. For example, the request for feedback 124 may comprise information such as name, contact information for a recently treated patient, as well as procedure information such as a practitioner, a procedure, etc., and other information necessary to retrieve feedback. Verified data collection system 110 may, in one embodiment, provide a post treatment survey 142 to patient 140. Post-treatment survey 142, in one embodiment, comprises an on-site survey provided prior to a patient leaving a facility. In another embodiment, post-treatment survey 142 is provided to patient 140 after a treatment is concluded, for example as a mail-in survey, an electronic survey, a telephonic survey, etc. Post treatment survey 142 may, in one embodiment, be provided such that it is unaffiliated with provider 120. However, in another embodiment, the post treatment survey 142 is sent to the patient 140 such that it indicates from which provider 120 (e.g. which practitioners, facilities, procedures, etc.) patient 140 received care. For example, post treatment survey 142 in one embodiment indicates that patient 140 saw a given practitioner, on a given date, at a given location, and interacted with given staff members, etc.

Post treatment survey 142, in one embodiment, is sent automatically through a digital form of communication, for example e-mail, SMS, or IVR (interactive voice response), or another suitable method. In another embodiment, post treatment survey 142 is conducted through the mail by the printing of trackable survey, mailing it to the patient for completion and return. Additionally, in at least one embodiment, post treatment survey 142 is conducted between a person associated with verified data collection system 110 and patient 140, for example either in person or over a phone call. Once patient 140 has completed post treatment survey 142, actual, verifiable patient data 144 is provided to verified data collection system 110. Data 144 is, in one embodiment, actual patient data provided by a verified patient 140 of a provider 120.

In one embodiment, verified data system 110 comprises at least a processor 112 and a communication component 114. Verified data collection system 110 also comprises, in one embodiment, one or more databases 118. Verified data collection system 100 may be configured to store requests for feedback, post treatment surveys, and verified patient data in databases 118. Databases 118 may be stored onsite by the verified data collection system 110, remotely stored, for example accessible through cloud-based or wireless network, stored onsite by a provider, or accessible through a combination of remote and onsite storage.

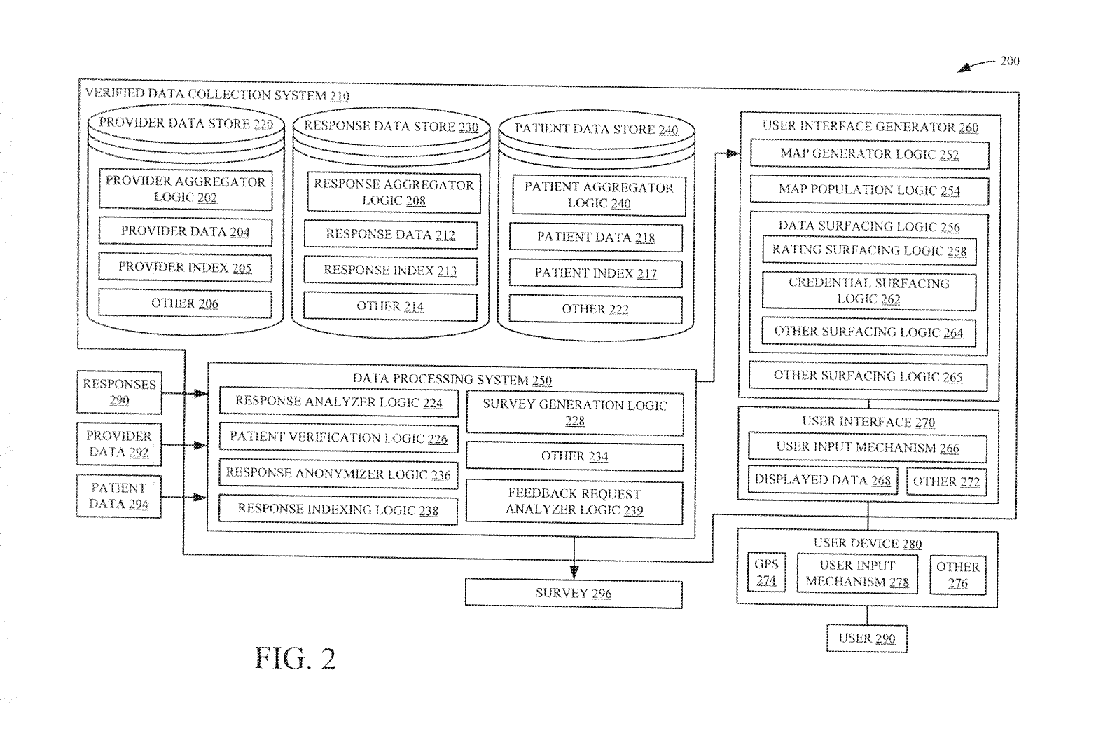

FIG. 2 illustrates a block diagram of a verified data collection system in accordance with one embodiment of the present invention. In one embodiment, verified data collection system 210 functions similarly to verified data collection system 110 described above with respect to FIG. 1. Verified data collection system 210 comprises one or more data stores, for example a provider data store 220, a response data store 230, and a patient data store 240. However, in one embodiment, all three types of data are stored in a single storage area, and the three separate data stores illustrated in FIG. 2 are provided for the sake of illustration only. However, in other embodiments, some or all of data store 220 through 240 are located remotely from, and accessed by data processing system 250.

Verified data collection system 210 comprises a provider data store 220. Provider data store 220 is configured to receive provider data 292, for example provided by data processing system 250, and aggregated by provider aggregator logic 202. Provider data store 220 is configured to store provider data 204. In one embodiment, provider data store 220 also comprises other data 206. Provider data may comprise, for example, any of healthcare companies, insurance companies, hospitals, practitioners, or data regarding any other part of the health care process such as operation data, patient visit data, etc. In another embodiment, provider data store 220 comprises a plurality of data stores specific to individual practitioners, insurance companies, healthcare facilities, etc.

Verified data collection system 210 also comprises, in one embodiment, a response data store 230. Response data store 230 is configured to receive incoming patient responses 290 from data processing system 250, and store them as response data 212 within response data store 230. Response data 212 comprises, in one embodiment, received post treatment feedback from one or more patients. In one embodiment, incoming response data 290 is received by data processing system 250. Response analyzer logic 224 is configured to retrieve and parse information within an incoming response 290, for example to parse out rating for a specific practitioner as well as a rating for a specific provider. Response anonymization logic 236 is configured to anonymize patient data within a response 290, in one embodiment prior to the data being sent to response data store 230. However, in another embodiment, response data 212 comprises patient information, and response anonymizer logic 236 does not act to remove specific patient information until such information is set to be displayed on a user interface, for example user interface 270.

Data processing system 250 is also configured to, in response to a request from a prospective patient, search data stores 220-240 and provide results in response to the request. In one embodiment, data processing system 250 in response to an incoming prospective patient request may utilize prospective patient request logic 239 to parse the request, and coordinate retrieval of results from data stores 220-240. For example, provider location and treatment options can be retrieved from provider data store, and feedback related to practitioners can be retrieved from response data store 230.

Verified data collection system 210 also comprises a patient data store 240. Patient data store 240 is configured to house patient data 218. Patient data 218 may comprise data about patients previously associated with provider data 204. In one embodiment, data processing system 250 receives incoming patient data 294. Incoming patient data 294 may comprise data about a patient prior to an operation. Patient verification logic 226 is configured, in one embodiment, to analyze a received response 290, and compare it to previously received patient data 294, or stored patient data 218, to verify that the response comes from an actual, verifiable patient, and concerns actual practitioners from which the patient received treatment. In one embodiment, based on incoming patient data 294, for example an indication that a user has undergone a specific treatment, data processing system 250 is configured to, using survey generation logic 228, generate and send a survey to a user. In one embodiment, survey generation logic 228 is configured to generate an output a survey 296. In one embodiment, the survey 296 may be output through a user interface, for example user interface 270. However, in another embodiment, survey 296 is provided through a communication component, for example communication component 114 described with respect to FIG. 1. Data processing system 250 may also comprise other functionality 254.

Verified data collection system 210 also comprises a user interface generator 260. One important feature of a verified data distribution system, such as system 210, is the ability to provide prospective patients with information about prospective practitioners, prospective providers, prospective facilities, etc. A prospective patient 290 may, using a user device 280, view a user interface 270. User interface 270 may comprise displayed data 268, and other information 272 in response to a request received from user device 280. For example, using device 280 may provide information to verified data collection system 210, for example device 280 may comprise GPS information 274 as well as other information 276 that may be useful in order to display information about local practitioners to a prospective patient. User 290, using a user input mechanism 278, can interact with user input mechanism 266 of a user interface 270 in order to provide a search request to a user interface generator 260.

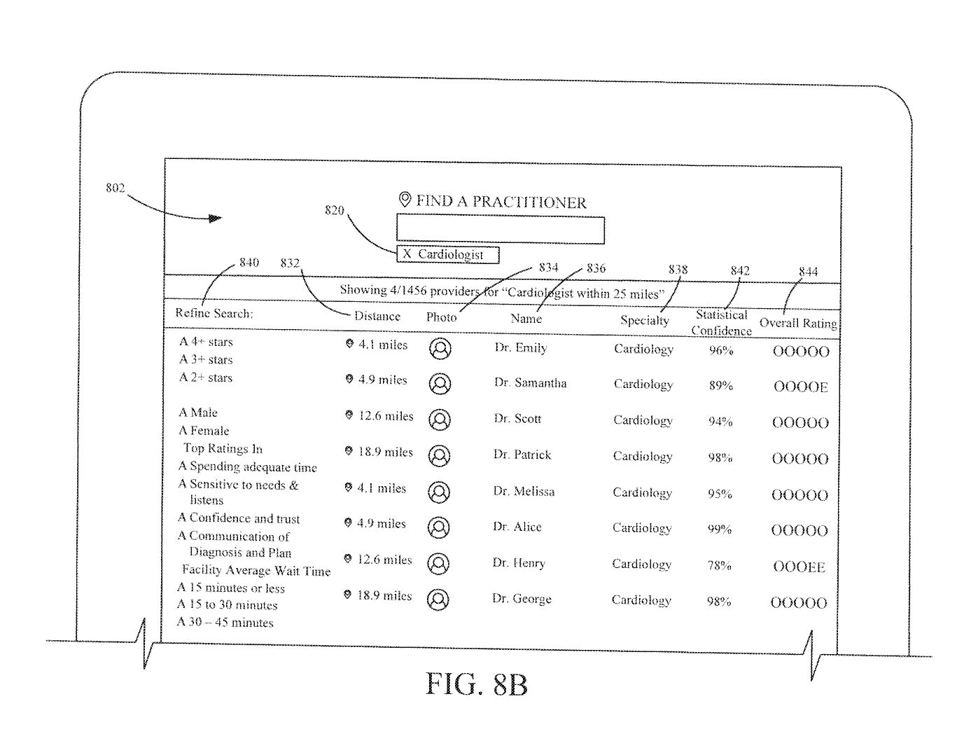

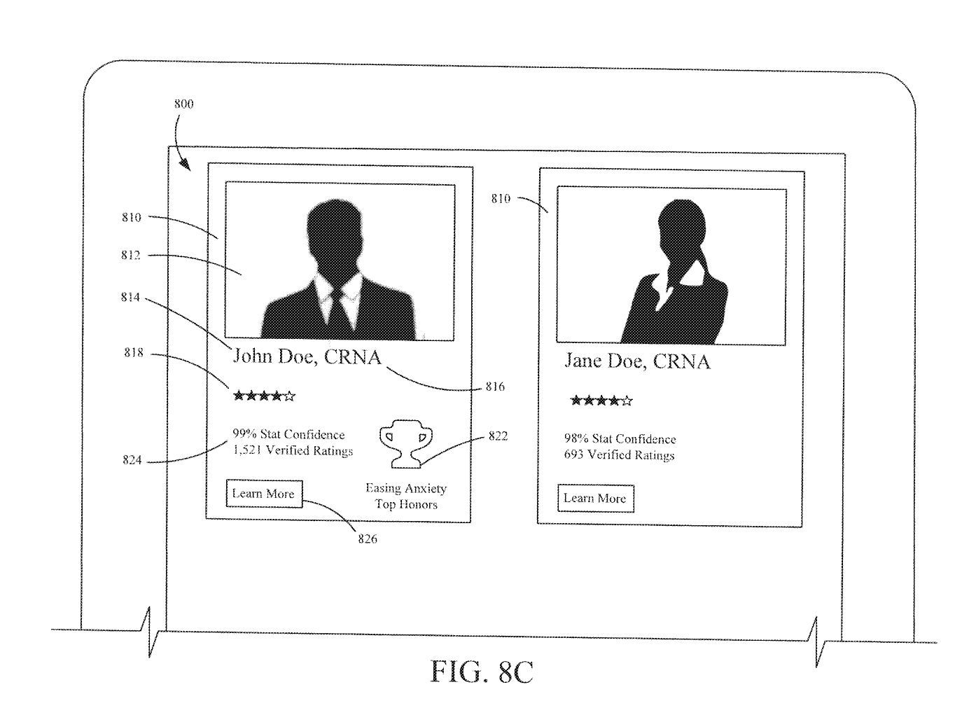

In response to a search request, user interface generator 260, using map generation logic 252, is configured to provide a map, for example shown and described with respect to FIG. 8A, of practitioners located within a specified distance from prospective patient 290. Map population logic 254 is configured to populate a map generated by map generator logic 252 with locations of practitioners local to prospective patient 290. Data surfacing logic 256 is configured to provide more detailed information about populated practitioners. For example, rating surfacing logic 258 is configured to communicate with response aggregator logic 208 in order to provide a prospective patient with rating information from actual, verifiable patients about practitioners and providers displayed on the user interface. Additionally, credential surfacing logic 262 is configured to communicate with provider aggregator logic 202 and provider index 205 in order to retrieve credentials for practitioners. Credentials can comprise, for example, indications that a given healthcare facility specializes in orthopedic surgery, that a given practitioner is an OBGYN, as well as information about awards that practitioners may have received. Additionally, other surfacing logic 264 can provide other information that would be helpful for the user in selecting a practitioner. Additionally, user interface generator 260 may comprise other surfacing logic 265 configured to surface other information as desired by a prospective patient.

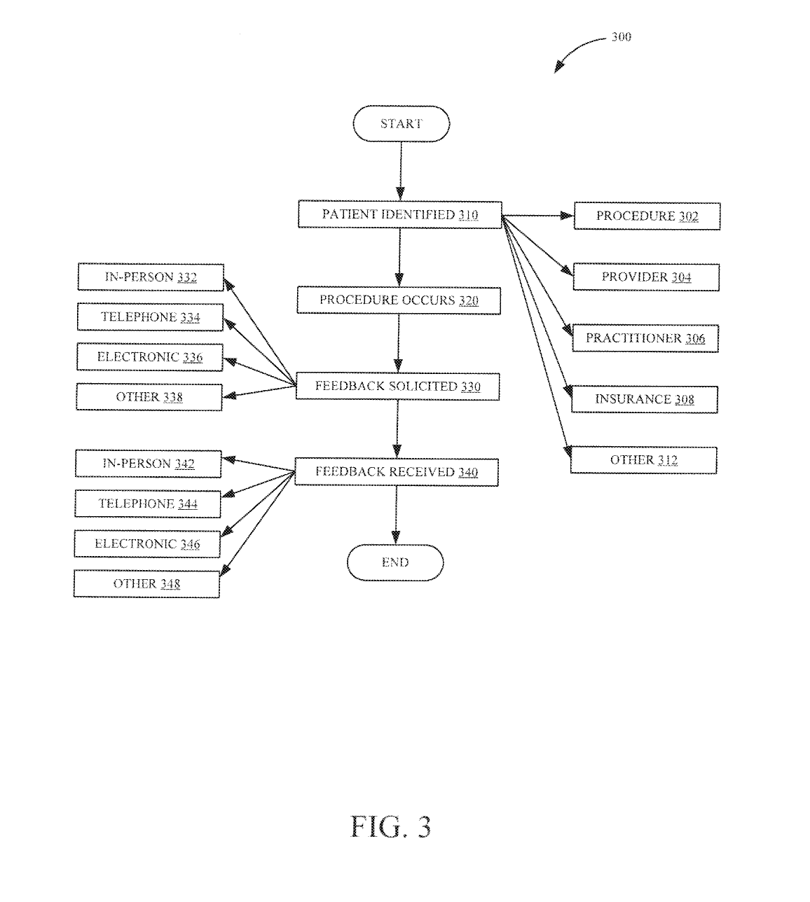

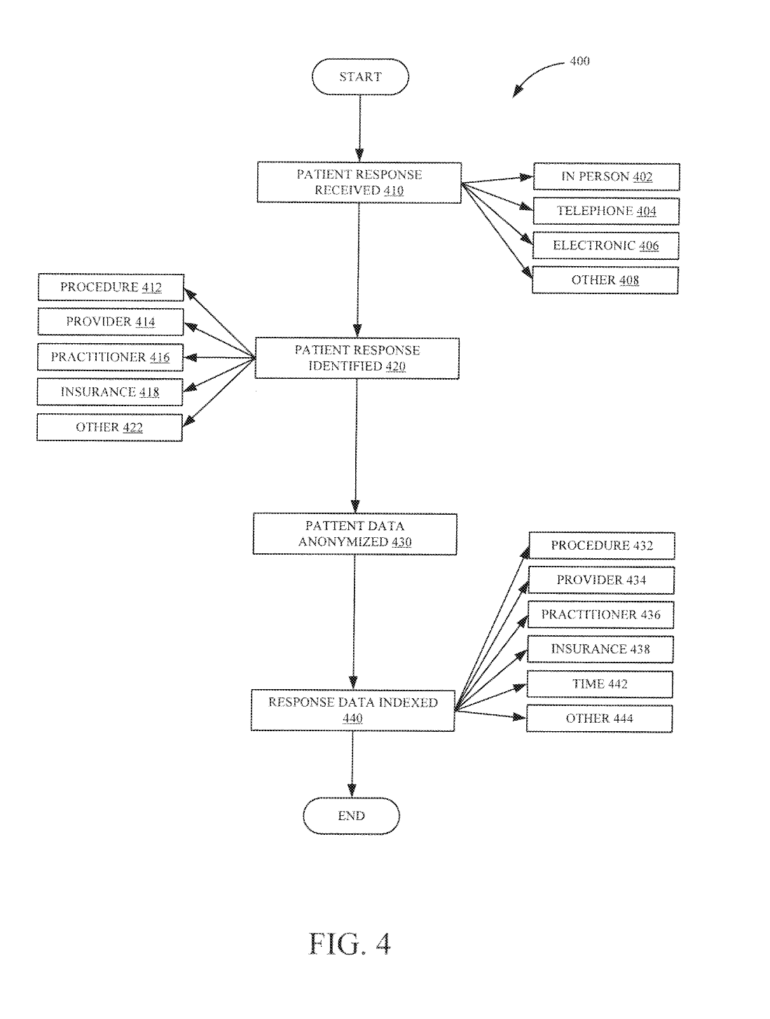

FIG. 3 illustrates a flow diagram of a method of obtaining verified patient feedback in accordance with one embodiment of the present invention. Method 300 may be useful for a verified data distribution system, such as verified data collection system 210 to ensure that only verified patient data is received and provided to prospective patients in response to a prospective patient request for information.

At block 310 a patient is identified. For example, data processing system 250 can receive incoming patient data 294, and patient verification logic 226 can verify that a patient is associated with, for example any of a procedure as indicated in block 302, a provider as indicated in block 304, a practitioner as indicated in block 306, an insurance company as indicated in block 308, or other verification criteria, as indicated in block 312. Identifying a patient prior to a procedure is helpful in order to ensure that the right patient receives a post treatment feedback survey that includes information about the right practitioner data.

At block 320 a procedure occurs. For example, a patient may go in for out-patient treatment, in-patient treatment, or may go through, for example a routine physical or other interaction with a practitioner.

At block 330 feedback is solicited. In one embodiment, feedback is solicited from all patients interacting with a practitioner. This may ensure that a practitioner is not able to influence practitioner rankings or practitioner information provided to a prospective patient. For example, in one embodiment, verified data collection system 210 is configured to solicit feedback anytime it receives an indication that a procedure has occurred. For example, feedback can be solicited from a patient after a procedure during a visit, as indicated in block 332. In another example, feedback can be solicited over the telephone, as indicated in block 334. Feedback can also be solicited in an electronic fashion, as indicated in block 336, for example by e-mail, online form, or any other suitable method. Additionally, feedback can be solicited in other ways, as indicated in block 338.

At block 340 feedback is received. Feedback may not be received from all patients to whom feedback was solicited. For example, some patients may choose not to complete feedback. However, feedback can be received, as indicated in block 340, in a variety of ways. For example, feedback can be received from a patient after a procedure during a visit, as indicated in block 342. In another example, feedback can be received over the telephone, and entered into an online form, or a response database, by verified data collection system 210, as indicated in block 344. Feedback can be received in an electronic fashion, as indicated in block 346, for example e-mail, entered into an online form, or any other suitable method. Additionally, feedback can be received in other ways, as indicated in block 348.

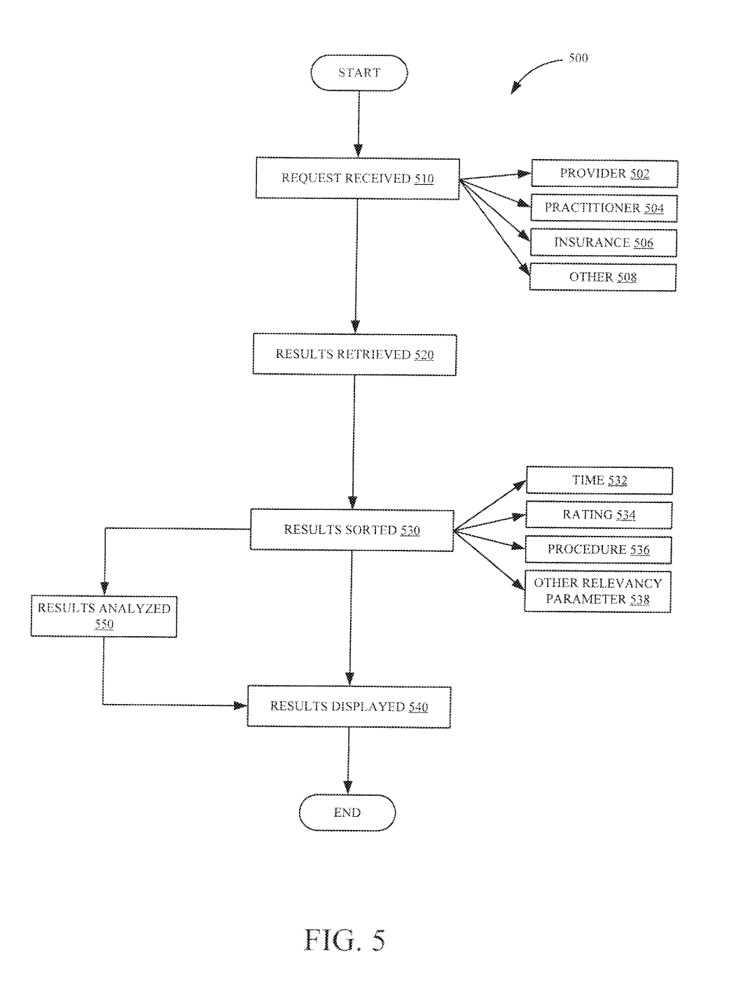

FIG. 4 illustrates a flow diagram of a method of indexing patient response data in accordance with one embodiment of the present invention. For example, in order for data surfacing logic 256 to retrieve anonymized information provided by previous patients, incoming response data needs to be indexed such that it is easily retrievable by provider aggregator logic, response aggregator logic, and patient data aggregator logic.

At block 410 a patient response is received. In one embodiment, receiving patient data comprises receiving data from a patient in an during a visit conducted interview, as indicated in block 402. Additionally, in one embodiment receiving patient data comprises receiving data over a telephonic interview, as indicated in block 404. For example, IVR may be used in order to record information from a patient after a procedure. Additionally, patient responses can be received in an electronic form, as indicated in block 406 or any other suitable method, as indicated in block 408.

At block 420, a patient response is identified. For example, patient verification logic 226, in conjunction with response analyzer logic 224 is configured to parse the received patient response to verify that a patient did receive treatment, and to verify that the treatment indicated in the response is the same as the treatment indicated by the provider. For example, this can comprise matching pre and post-operation information with regard to a procedure or treatment, as indicated in block 412, to verify that a user received the treatment indicated by the provider. Additionally, a provider may be verified, as indicated in block 414. Identifying patient response information can also comprise verifying a practitioner, as indicated in block 416. In another embodiment, verifying patient response comprises verifying insurance information, as indicated in block 418. Additionally, other information can also be verified, as indicated in block 422, as provided by a patient, or requested by a provider or practitioner.

At block 430 patient data is anonymized. For example, each patient may be identified by a patient code, such that patient data can be retrieved by accessing a patient index 217. However, it is important that data be provided to the provider or practitioner in an anonymized fashion, both to protect patient identity and privacy. Additionally, patient data is anonymized such that a prospective patient does not see patient identifying information, but only their responses to post treatment feedback requests, for example provided during, or after, a visit.

At block 440 response data is indexed. For example, response data, including patient text comments, can be indexed in a response index 213. This may allow for data surfacing logic 256 to easily access pertinent response data 212 in response to a prospective patient request, including keywords. For example, response data can be indexed by procedure, as indicated in block 432, such that a prospective patient can search by a procedure that they want or need to undergo. Response data can also be indexed with respect to a provider as indicated in block 434, such that a user can retrieve information for a desired provider, for example only for Allina Hospitals, or only for the Mayo Clinic. Additionally, response data can be indexed by a practitioner as indicated in block 436. This may allow a patient to retrieve information specific to a practitioner to whom they have been referred, or to search by practitioners with given response criteria. Additionally, response data can be indexed by insurance company, as indicated in block 438. Additionally, response data can also be indexed by time, as indicated in block 442. For example, a patient may wish to receive information only about a given procedure within the last five years, within the last six months, or any other appropriate time period. Response data can also be indexed by other criteria as indicated in block 444, as required by a provider or practitioner, or requested by prospective patients.

FIG. 5 illustrates a flow diagram of a method of displaying search results in accordance with one embodiment of the present invention. For example, a feedback request can come from a provider interested in improving their services. Additionally, a prospective patient request can also be received, for example, indicating a desire to see nearby practitioners offering a needed treatment.

At block 510 a request is received. A request can be received from a prospective patient 290 using a device 280 to access the verified data collection system 210. The prospective patient may request information about a specific provider, as indicated in block 502. A prospective patient can also request information about a specific practitioner, as indicated in block 504. Additionally, a prospective patient could also request information about a specific insurance company, for example their coverage in an area, as indicated in block 506. Additionally, a prospective patient can request information about any number of other healthcare related information about their area, as indicated in block 508.

At block 520, results are received. In one embodiment, data processing system 250 in response to an incoming prospective patient request may utilize prospective patient request logic 239 to parse the request, and coordinate retrieval of results. For example, prospective patient request logic 239 may, in conjunction with provider aggregator logic 202, and response aggregator logic 208 access provider index 205 and response index 213 in order to retrieve the requested information.

At block 530, the results are sorted. In one embodiment, results are sorted based on time of procedure, or time of feedback request, as indicated in block 532. Additionally, in one embodiment, results are sorted by a rating given to an indicated provider/practitioner/etc., as indicated in block 534. Additionally, the results can be sorted by procedure, as indicated in block 536. Additionally, results can be sorted by relevancy parameters indicated by the prospective patient, as indicated in block 538.

In one embodiment, prior to results being given to a user, results are analyzed, as indicated in block 550. For example, a prospective patient may want a comparison to find the best practitioner that is suitable for them. Data processing system 250, for example using response analyzer logic 224, may provide analyzed feedback to the prospective patient about the retrieved results. Additionally, for example, analysis can be provided to a practitioner, in conjunction with, or as an alternative to raw survey results.

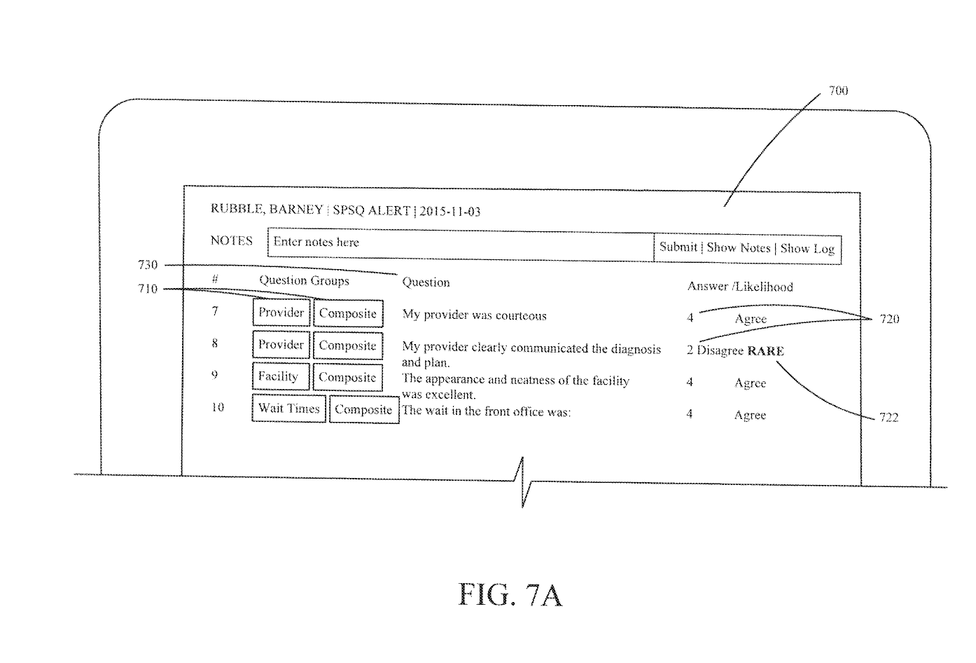

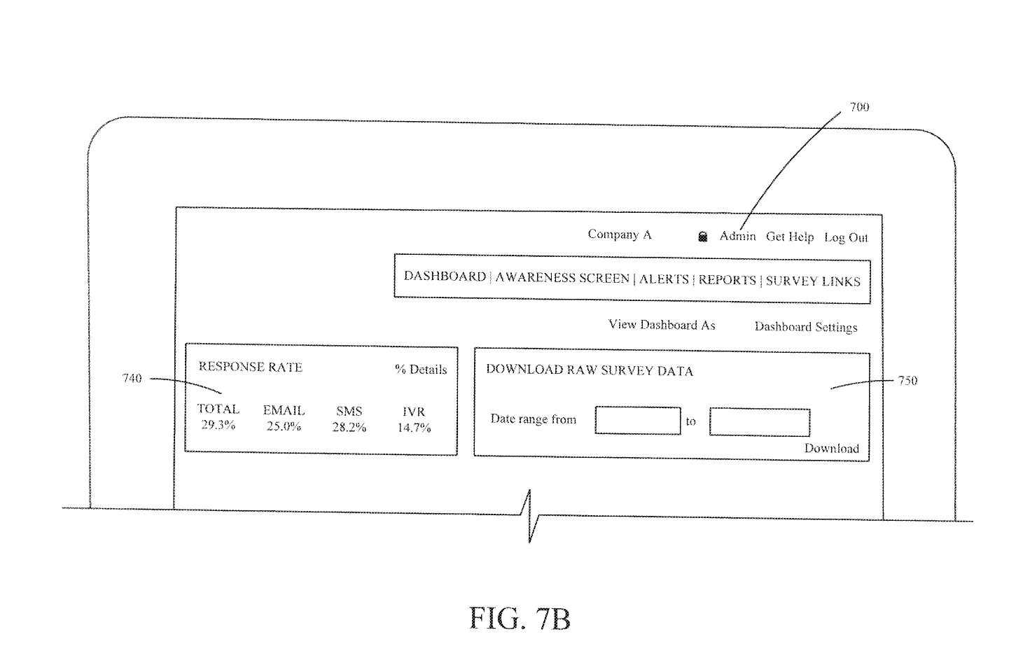

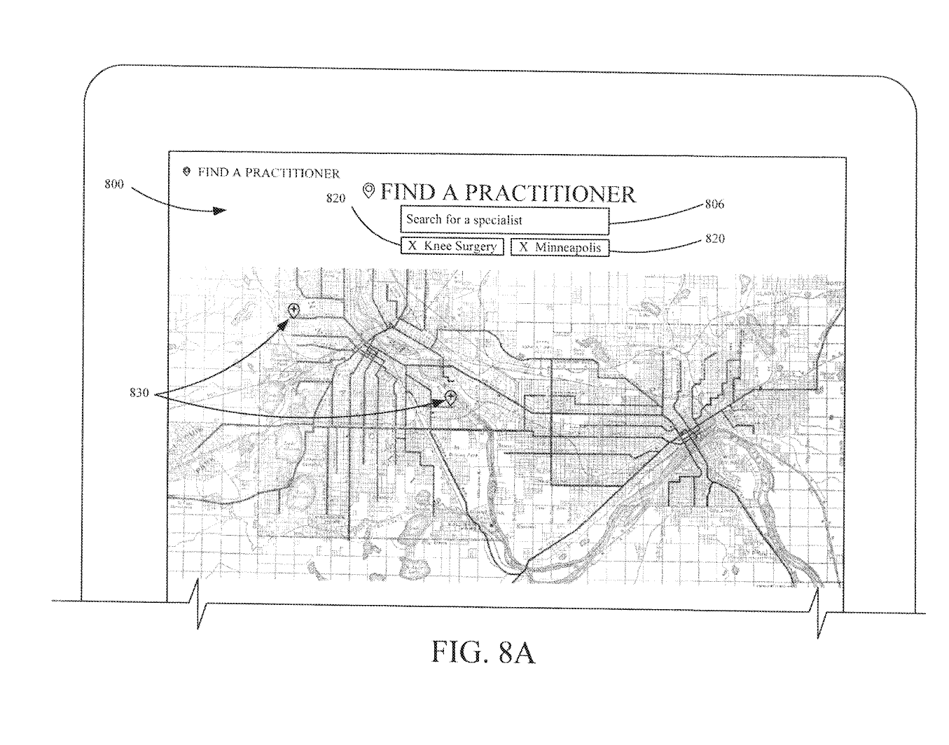

At block 540 results are displayed. For example, results can be presented to a practitioner using interfaces discussed in further detail with respect to FIGS. 7A and 7B. Alternatively, map generator logic 252, in one embodiment, is configured to generate a map displayed on a user interface 270 in response to a request from a prospective patient, as illustrated in FIG. 8A. Additionally, map population logic 254, in one embodiment, is configured to populate the generated map with retrieved practitioner information from provider data 204. Additionally, data surfacing logic 256 is configured to provide additional information requested by prospective patient 290.

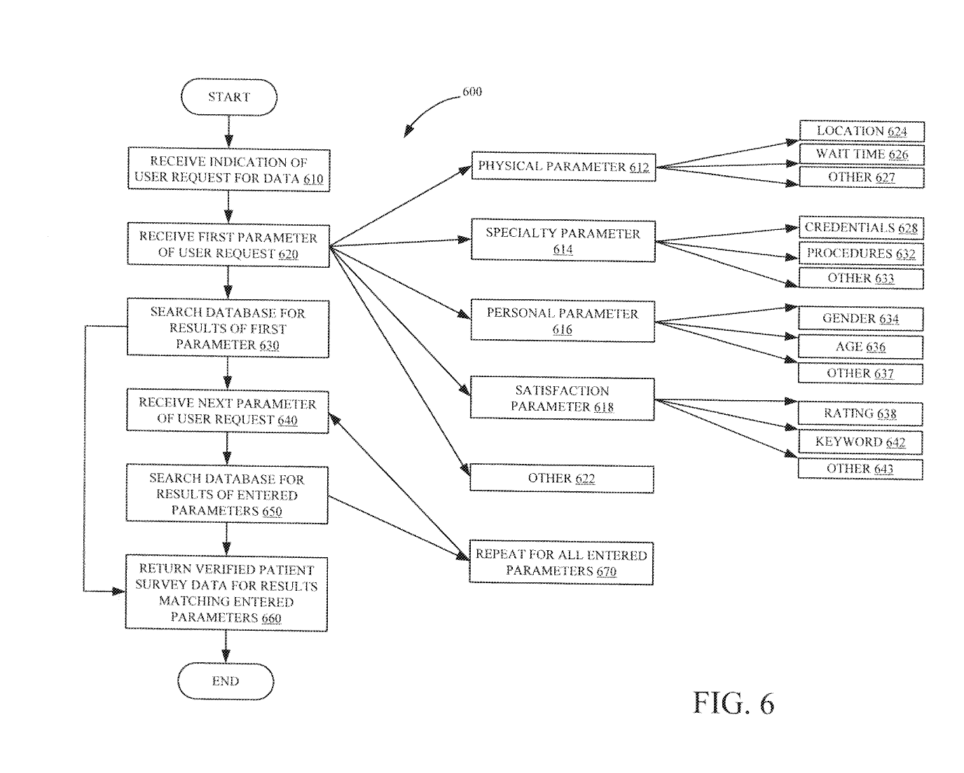

FIG. 6 illustrates a flow diagram of a method of delivering verified patient survey results in accordance with one embodiment of the present invention. Method 600 comprises one example process for providing verified patient information to either of prospective patients, or to providers interested in detailed information about patient feedback regarding their practice.

At block 610, an indication is received of a user request for data. The indication could come from a practitioner, for example interacting with a dashboard, as illustrated in FIGS. 7A-7B. The indication may also comprise, for example, a prospective patient entering a first search criterion within a search bar, as illustrated in FIG. 8A. In another embodiment, the indication may comprise multiple search parameters entered by a prospective patient, as illustrated in more detail in FIG. 8B. In one embodiment, a prospective patient 290, using user input mechanism 278 on a device 280 enters a first search criteria. However, in another embodiment, the first search criteria comprises data processing system 250 receiving GPS information 274 from a device 280, and, in response, map generator logic 252 and map population logic 254 populating a map with information about practitioners in the prospective patient's area.

At block 620, a first parameter of a request is received. Depending on whether the request originates from a practitioner or a prospective patient, a variety of parameters may be entered, and processed, by a verified data collection system 210, and results matching the requested parameters can be surfaced by data surfacing logic 256, and presented as displayed data 268 on user interface 270.

The first parameter may comprise, for example a physical parameter 612 which can correspond to a location 624 of facility or specialist, or a wait time for a facility or specialist, as indicated in block 626. Other physical parameters may also be entered, for example as indicated in block 627. For example, prospective patient 290 may only be interested in specialists within a 25-mile radius of their home. Additionally, a prospective patient 290 may need a procedure done within a certain timeframe, and therefor is interested only in practitioners within a given wait time, as indicated in block 626.

However, an entered parameter may also be specialty parameter, in one embodiment, as indicated in block 614. A specialty parameter can comprise certain credentials, as indicated in block 628, or procedure related information, as indicated in block 632. Other specialty-related relevancy requirements can also be specified, as indicated in block 633. For example, a prospective patient may be interested in seeing a cardiologist, and may enter such credentials. Additionally, a patient may also be concerned about having a newer practitioner, and may enter a minimum number of procedures completed, as indicated in block 632 as a given parameter.

In one embodiment, the entered parameter is a personal parameter, as indicated in block 616, for example a desire to see a practitioner with a given gender, as indicated in block 634, or age as indicated in block 636. For example, if the prospective patient 290 is a pregnant woman, they may prefer an OBGYN that is female and can indicate that using gender parameter 634. Other personal parameters can also be entered, as indicated in block 637.

A prospective patient may also enter a satisfaction related parameter, as indicated in block 618. For example, a prospective patient may only wish to see practitioners with a minimum rating, as indicated in block 638, or practitioners whose results match a keyword, as indicated in block 642. For example, a patient may look for practitioners whose reviews indicate that the practitioner is comforting, or has a good bedside manner. Other specialty-related parameters may also be entered, as indicated in block 643. Additionally, verified data collection system 210 may also be configured to receive other appropriate relevancy parameters, as indicated in block 622.

In block 630, based on the results of an entered parameter, response data store 230 is searched for results that match the parameter, and response aggregator logic 208 is configured to retrieve all response matching the required information. In one embodiment, after a parameter has been applied to response data store, all results meeting that parameter are immediately provided to the user by data surfacing logic 256.

At block 740, an additional parameter is received by a prospective patient. For example, in response to a first request, a prospective patient may receive 100 results that match their first criteria. A user may then wish to narrow the results by entering a second parameter. For example, a user may first enter a location parameter, as indicated in block 624, and may then enter a ratings parameter as indicated in block 638, such that they can find the highest rated specialists in their area. In response to the received parameter request, data processing system 240 is configured to, using prospective patient request logic 239, communicate with response data store 230, and use response aggregator logic 208 to parse response data 212 in response index 213 to find responses matching the requested parameters.

At block 650, the database is searched for results that match all currently entered parameters. In one embodiment, searching response data store 230 comprises only searching the initially received results based on the first entered parameter, such that the entire response index 213 is not searched a second time, but only the responses that match the first criteria are searched for compliance with the second criteria.

At block 670, the process of receiving a new parameter and searching the database for matching results is repeated for as many parameters as the prospective patient 290 wishes to enter. However, in one embodiment, the response data 212 and response index 213 are only searched with respect to results previously provided, this may shorten a search time, for example as each parameter narrows down a result set.

At block 660, verified patient survey results are provided to a prospective patient 290 based on parameters entered through user interface 270. The ability to provide actual patient survey information and patient rating information to prospective patients ensures that prospective patients have the most accurate information about practitioners of interest to them. It also ensures practitioners that information provided by a verified data collection system 210 is accurate, because the information is provided from actual, verified patients who interacted with the practitioner in question.

FIGS. 7A and 7B illustrate exemplary user interfaces generated for a practitioner by a verified data collection system in accordance with one embodiment of the resent invention. For example, verified data collection system 210, using user interface generator 260, may be configured to present analyzed response feedback in response to a request from a practitioner.

FIG. 7A illustrates an exemplary user interface 700 that may be provided to an exemplary practitioner, for example Barney Rubble. In one embodiment, user interface 700 comprises one or more question indices 710, one or more questions 730 sent to a patient, and one or more answers 720. Answers 720, in one embodiment, are provided in conjunction with associated answer likelihood 722. For example, as illustrated in FIG. 7A, in response to the question “My practitioner clearly communicated the diagnosis and plan” one patient answered that they disagreed which is a rare answer for that question. While 7A illustrates a likelihood in words, percentages may also be given, for example “rare” may indicate a 10% frequency or lower for a given response. In one embodiment, the user interface is generated by user interface generator 260. Data surfacing logic 256 using other surfacing logic 264 can retrieve, from a provider index 205 and a response index 213, the answers provided by actual patients, to surveys sent through survey generation logic 228.

In one embodiment, questions 730 are grouped by type, for example composite questions concerning a patient's overall stay, practitioner-based questions concerning a specific practitioner, facility-based questions concerning the facility in which the operation took place, or other question groups as desired by the practitioner, patient, or set by verified data collection system 210.

FIG. 7B illustrates an exemplary dashboard 700 presented to a practitioner by verified patient data collection system 210. Dashboard 700 may comprise a response rate section 740 that indicates different response rates for different survey formats, in one embodiment. For example, in one embodiment, surveys may be sent in multiple formats to multiple patients, based on either patient or provider request. For example, a patient may indicate that they wish to receive a survey through e-mail, SMS service, IVR service, or other. Additionally, surveys may be first sent by a first service type, and if a response is not received, a second service type may be used. For example, an e-mail format may be used initially, with text message reminders sent through an SMS service. Additionally, through dashboard 700, a provider may be able to download raw survey results 750, for example by providing a specific date range, a specific practitioner, or another filter option, such that providers can do their own data analysis. However, while response data 212 and response index 213 may be accessible by a provider, response anonymizer logic 236 may first parse all patient privacy information from response data 212, such that the provider only receives anonymized results, and does not have access to specific patient data.

FIGS. 8A-8C illustrate exemplary patient user interfaces generated by verified data collection system in accordance with one embodiment of the present invention. In one embodiment, a user may be able to switch between user interfaces illustrated in FIGS. 8A, 8B, and 8C, according to their preferred search methodology.

FIG. 8A illustrates an exemplary user interface 800 presented to a prospective patient 290 that allows the prospective patient to search, based on a variety of keywords or filter options for a practitioner in a given area. For example, as indicated in FIG. 8A, prospective patient 290 has searched, using search bar 806 for a specialist who can provide knee surgery located in or near Minneapolis, Minn. Any of filters 820 may be applied to a given search, such that a patient may provide one search filter at time, or any number of filters according to their preference or needs. Additionally, interface 800 may provide one or more result indications 830 indicating on a map where specialists are found that match the indicated criteria.

FIG. 8B illustrates an exemplary user interface 800 that may be provided to prospective patients, for example based on an initial search. User interface 800, as illustrated in FIG. 8B, shows that a prospective patient has indicated a desire to view all nearby specialists who are cardiologists. A user may be able to further refine their search by selecting one or more filter options 840. The user may be able to rank the results by a plurality of options, for example distance as indicated in block 832, practitioner photo, as indicated in block 834, name as indicated in block 836, specialty as indicated in block 538, statistical confidence, as indicated in block 842, or an overall rating, as indicated in block 844.

FIG. 8C illustrates an exemplary user interface 800 that may be provided to a prospective patient using a verified patient data distribution system 210. User interface 800 illustrates a plurality of specialist cards 850 that may be presented to a prospective patient 290 in response to a search result. Specialist card 850 may comprise, in one embodiment, a photo 812, a name 814, a rating 818, a statistical confidence 824, a credential 816, an award 822, and/or an option to go to an expanded view 826. As illustrated in FIG. 8C, an exemplary practitioner John Doe has received top honors, for example as rewarded by verified patient data distribution system based on patient reviews, for easing patient anxiety as indicated by award 822. Awards 822 may be searchable by a prospective patient in some embodiments. Additionally, a given practitioner may be able to control which awards are shown in awards section 822, however in at least some embodiments, the practitioner is not able to select awards not granted or verified by patient data distribution system 210.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

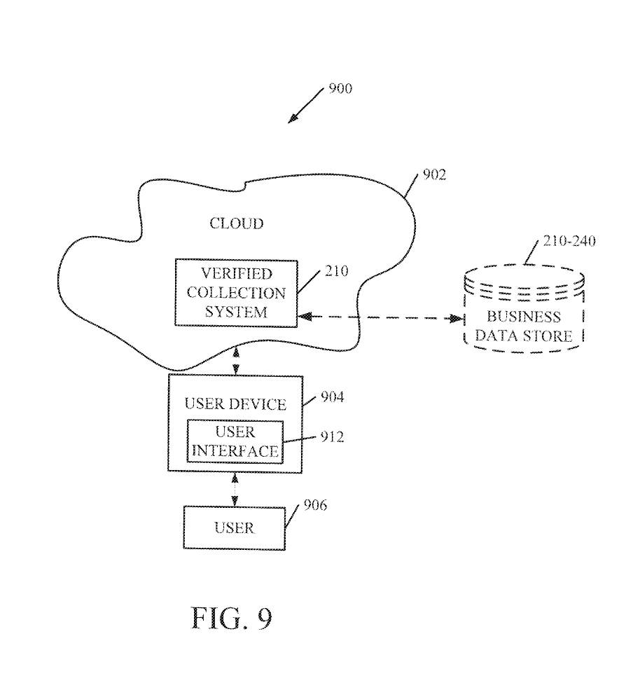

FIG. 9 is a block diagram of a verified data collection system 210 described with respect to FIG. 2, except that its elements are disposed in a cloud computing architecture 1000. Cloud computing provides computation, software, data access and storage services that do not require end user knowledge of the physical location or configuration of the system that delivers the services. In various embodiments, cloud computing delivers the services over a wide area network, such as the Internet, using appropriate protocols. For instance, cloud computing providers deliver applications over a wide area network such that they can be accessed through a web browser or other computing component. Software or components of system 210 as well as the corresponding data can be stored on servers at remote location. The computing resources in cloud computing environments can be consolidated at remote data center locations or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

In the embodiment shown in FIG. 9, some items are similar to those shown in FIG. 2, and they are similarly numbered. FIG. 9 specifically shows that systems 210 is located in cloud 902 (which can be public, private, or a combination where portions are public while others are private). Therefore, user 1006 can use a user device 1004 to access system 210 through cloud 1002.

FIG. 9 depicts an embodiment of cloud architecture where data stores 220-240 are disposed outside of cloud 1002, and accessed through cloud 1002. In another embodiment, data processing system 250 is also disposed outside of cloud 1002. Regardless of where they are located, data stores 220-240, and system 250 can be accessed directly by device 1004, through a network (either a wide area network or a local area network). It can be hosted at a remote site by a service, or it can be provided as a service through a cloud or accessed by a connection service that resides in the cloud. All of these architectures are contemplated herein.

It will also be noted that system 210, or portions of it, can be disposed on a wide variety of different devices. Some of these devices include servers, desktop computers, laptop computer, tablet computers, or other mobile devices such as palm top computers, cell phones, smartphones, multi-media players, personal digital assistance, etc.

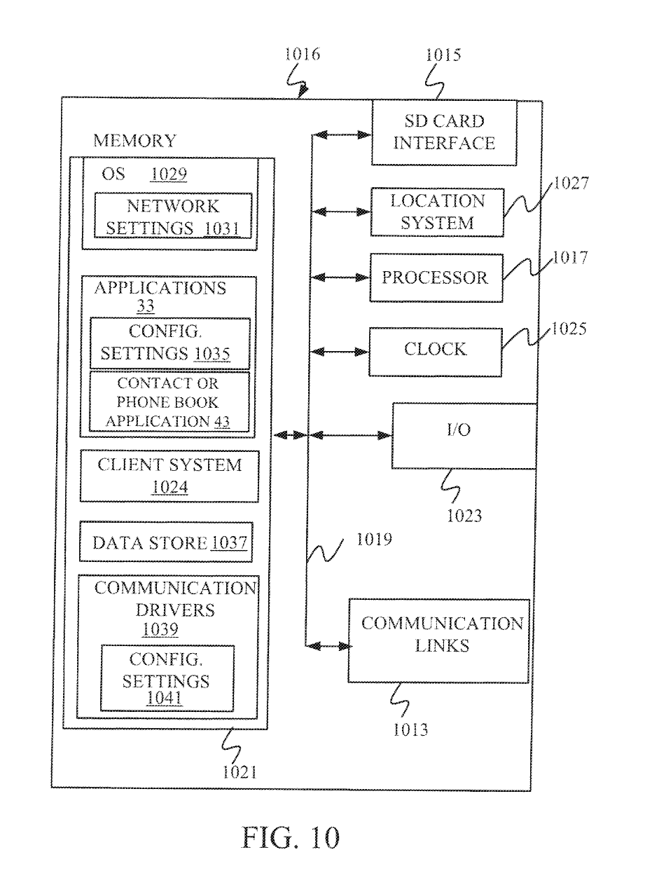

FIG. 10 is a simplified block diagram of one illustrative embodiment of a handheld or mobile computing device that can be used as a user's or client's handheld device 16 in which the present system (or parts of it) can be deployed. FIGS. 10-12 are examples of handheld or mobile devices. FIG. 10 provides a general block diagram of the components of a client device 16 that can run components or system 210 or then interacts with architecture 900, or both. In the device 16, a communications link 13 is provided that allows the handheld device to communicate with other computing devices, and under some embodiments, provides a channel for receiving information automatically, such as by scanning. Examples of communications link 13 include an infrared port, a serial/USB port, a cable network port such as an Ethernet port, and a wireless network port allowing communications through one of more communication protocols including General Packet RadioService (GPRS). LTE, HSPA, HSPA+ and other 3G and 4G radio protocols, 1×rtt, and Short Message Service, which are wireless services used to provide cellular access to a network, as well as Wi-Fi protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor along a bus 19 that is also connected to memory 21 and input/output (I/O) components 23, as well as clock 25 and location system 27.

I/O components 23, in various embodiments, are provided to facilitate input and output operations. I/O components 23 of the device 16 can include input components such as buttons, touch sensors, multi-touch sensors, optical or video sensors, voice sensors, touch screens, proximity sensors, microphones, tilt sensors, and gravity switches and output components such as a display device, a speaker, and/or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media. Memory 21 stores computer readable instructions that, when executed by processor 17, cause the processor to perform computer-implemented steps or functions according to the instructions. Items in data stores 220-240, for example, can reside in memory 21. Similarly, device 16 can have a client business system 24 which can run various business applications. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

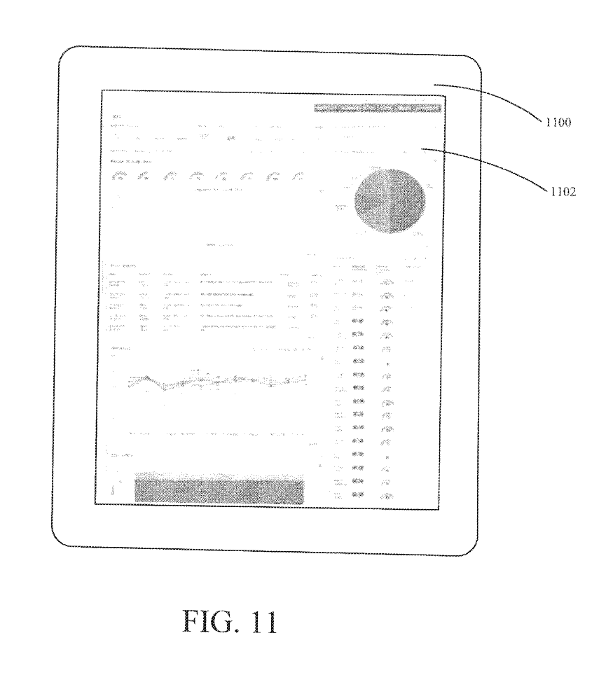

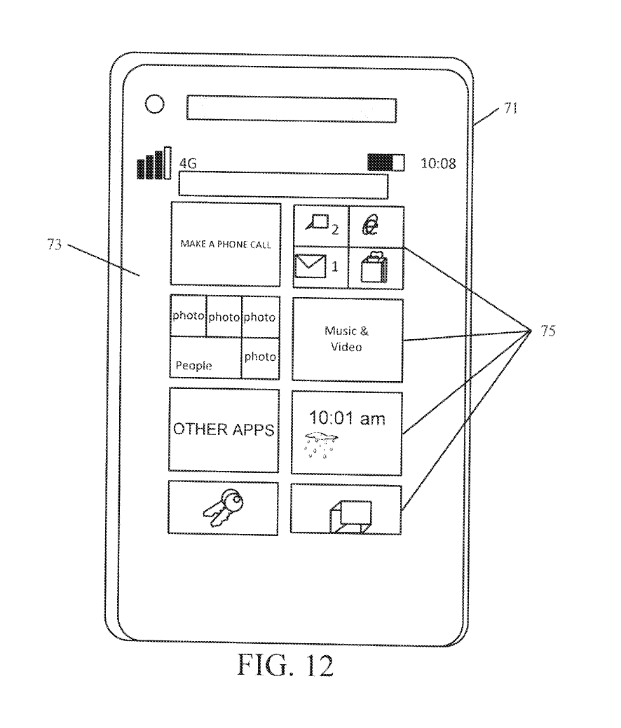

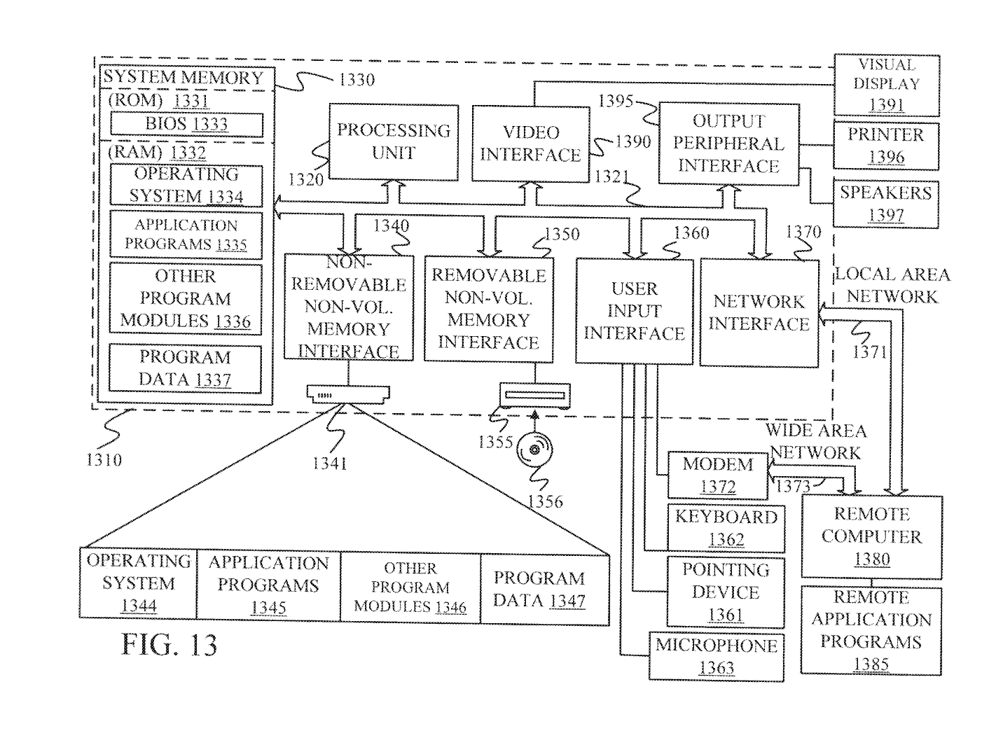

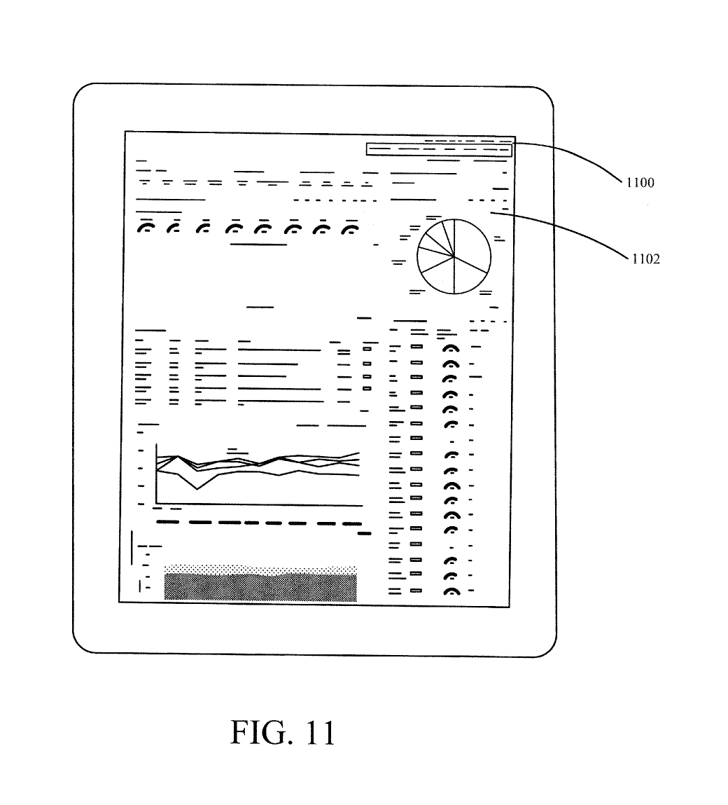

FIG. 11 shows one embodiment in which device 16 is a tablet computer 1100. Screen 1102 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 1100 can also illustratively receive voice inputs as well.

Tablet 1100 may be useful for a view of verified data collection system 210 to review information received. Illustrated in FIG. 11 is one example view provided to a requesting practitioner, illustrating some analyzed feedback. In another embodiment, screen 1002 presents a prospective patient 290 with requested information pertaining to a given practitioner, including survey results in actual patient testimony. In another embodiment, screen 1002 is provided to a patient during or after a survey, allowing for easy entry of survey information and, for example, providing aggregate survey results from other actual patients.

Additional examples of device 16 can be used as well. Device 16 can be a feature phone, smart phone or mobile phone. The phone can include a set of keypads for dialing phone numbers, a display capable of displaying images including application images, icons, web pages, photographs, and video, and control buttons for selecting items shown on the display. The phone can include an antenna for receiving cellular phone signals such as General Packet Radio Service (GPRS) and 1×rtt, and Short Message Service (SMS) signals. In some examples the phone also includes a Secure Digital (SD) card slot that accepts a SD card.

The mobile device can also be a personal digital assistant or a multimedia player or a tablet computing device, etc. (hereinafter referred to as a PDA). The PDA can include an inductive screen that senses the position of a stylus (or other pointers, such as a user's finger) when the stylus is positioned over the screen. This allows the user to select, highlight, and move items on the screen as well as draw and write. The PDA can also include a number of user input keys or buttons which allow the user to scroll through menu options or other display options which are displayed on the display, and allow the user to change applications or select user input functions, without contacting the display. The PDA can also include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections.

FIG. 12 is similar to FIG. 10 except that the phone is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the device 16 are possible.

FIG. 13 is one embodiment of a computing environment in which architecture 210, or parts of it, for example can be deployed. With reference to FIG. 13, an exemplary system for implementing some embodiments includes a general-purpose computing device in the form of a computer 1310. Components of computer 1310 may include, but are not limited to, a processing unit 1320, a system memory 1330, and a system bus 1321 that couples various system components including the system memory to the processing unit 1320. The system bus 1321 may be any of several types of bus structures including a memory bus or memory controller, a peripheral bus, or a local bus using any of a variety of bus structures. By way of example, and not by limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 2 can be deployed in corresponding portions of FIG. 13.

Computer 1310 typically includes a variety of computer readable media. Computer readable media can be any available media that can be accessed by computer 1310 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to: RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1310. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 1330 includes computer storage media in the form of volatile and/or nonvolatile memory such as read only memory (ROM) 1331 and random access memory (RAM) 1332. A basic input/output system 1333 (BIOS), containing the basic routines that help to transfer information between elements within computer 810, such as during start-up, is typically stored in ROM 1331. RAM 1332 typically contains data and/or program modules that are immediately accessible to and/or presently being operated on by processing unit 1320. By way of example, and not limitation, FIG. 13 illustrates operating system 1334, application programs 1335, other program modules 1336, and program data 1337.

The computer 1310 may also include other removable/non-removable volatile/nonvolatile computer storage media. By way of example only, FIG. 13 illustrates a hard disk drive 1341 that reads from or writes to non-removable, nonvolatile magnetic media, a magnetic disk drive 1350 that reads from or writes to a removable, nonvolatile magnetic disk 1352, and an optical disk drive 1355 that reads from or writes to a removable, nonvolatile optical disk 1356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1341 is typically connected to the system bus 1321 through a non-removable memory interface such as interface 1340, and magnetic disk drive 1341 and optical disk drive 1355 are typically connected to the system bus 1321 by a removable memory interface, such as interface 1350.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs). Program-specific Standard Products (ASSPs), System-on-a-chip systems (SOCs), Complex Programmable Logic Devices (CPLDs), etc.

The drives and their associated computer storage media discussed above and illustrated in FIG. 13, provide storage of computer readable instructions, data structures, program modules and other data for the computer 1310. In FIG. 13, for example, hard disk drive 1341 is illustrated as storing operating system 1344, application programs 1345, other program modules 1346, and program data 1347. Note that these components can either be the same as or different from operating system 1334, application programs 1335, other program modules 1336, and program data 1337. Operating system 1344, application programs 1345, other program modules 1346, and program data 1347 are given different numbers here to illustrate that, at a minimum, they are different copies.

A user may enter commands and information into the computer 1310 through input devices such as a keyboard 1362, a microphone 1363, and a pointing device 1361, such as a mouse, trackball or touch pad. Other input devices (not shown) may include a joystick, game pad, satellite dish, scanner, or the like. These and other input devices are often connected to the processing unit 1320 through a user input interface 1360 that is coupled to the system bus, but may be connected by other interface and bus structures, such as a parallel port, game port or a universal serial bus (USB). A visual display 1391 or other type of display device is also connected to the system bus 1321 via an interface, such as a video interface 1390. In addition to the monitor, computers may also include other peripheral output devices such as speakers 1397 and printer 1396, which may be connected through an output peripheral interface 1395.

The computer 1310 is operated in a networked environment using logical connections to one or more remote computers, such as a remote computer 1380. The remote computer 1380 may be a personal computer, a hand-held device, a server, a router, a network PC, a peer device or other common network node, and typically includes many or all of the elements described above relative to the computer 1310. The logical connections depicted in FIG. 13 include a local area network (LAN) 1371 and a wide area network (WAN) 1373, but may also include other networks. Such networking environments are commonplace in offices, enterprise-wide computer networks, intranets and the Internet.

When used in a LAN networking environment, the computer 1310 is connected to the LAN 1371 through a network interface or adapter 1370. When used in a WAN networking environment, the computer 1310 typically includes a modem 1372 or other means for establishing communications over the WAN 1373, such as the Internet. The modem 1372, which may be internal or external, may be connected to the system bus 1321 via the user input interface 1360, or other appropriate mechanism. In a networked environment, program modules depicted relative to the computer 1310, or portions thereof, may be stored in the remote memory storage device. By way of example, and not limitation, FIG. 13 illustrates remote application programs 1385 as residing on remote computer 1380. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Although the present invention has been described with reference to preferred embodiments, workers skilled in the art will recognize that changes may be made in form and detail without departing from the spirit and scope of the invention.

What is claimed is:

1. A verified patient data collection system configured to aggregate and provide verified patient feedback, the system comprising:
a data store comprising patient data and provider data;
a data processing system configured to, using the patient data and the provider data:
generate a patient survey to a verified patient, using survey generation logic; and
analyze a survey response from the verified patient, using response analyzer logic to generate the verified patient feedback;
a response data store configured to store the analyzed survey response, verified patient feedback, and a searchable response index; and
wherein, in response to a request for feedback, the data processing system is configured to, using surfacing logic, search the response index and provide the verified patient feedback.

2. The verified patient data collection system of claim 1, wherein the verified patient feedback is provided, on a user interface, in response to a request for feedback from a practitioner.

3. The verified patient data collection system of claim 1, wherein the verified patient feedback is provided, on a user interface, in response to a request for feedback from a perspective patient.

4. The verified patient data collection system of claim 3, wherein the verified patient feedback is provided in conjunction with a location indication, wherein the location indication comprises an indication of where the verified patient received treatment.

5. The verified patient data collection system of claim 1, wherein the verified patient feedback is provided in conjunction with anonymized feedback from the analyzed survey response.

6. The verified patient data collection system of claim 1, wherein the response data store is configured to store anonymized patient response data free of patient identifying information.

7. The verified patient data collection system of claim 1, wherein the data processing system is configured to, in response to the request for feedback, search the response index based on a received relevancy criteria.

8. The verified patient data collection system of claim 1, wherein the survey is generated in response to a received indication that the patient underwent a procedure.

9. The verified patient data collection system of claim 8, wherein the procedure is associated with an indication selected from the group consisting of: a provider, a practitioner, an insurance company, a procedure type, and a procedure date.

10. A method for providing verified patient response data in response, the method comprising:
receiving, from a requesting entity, a request for the verified patient response data;
identifying, using feedback request analyzer logic, a parameter within the request;
searching, using response aggregator logic, a response index stored within a response database for one or more patient responses matching the parameter of the request, wherein the response database comprises feedback from verified patients;
aggregating, using response aggregator logic, the one or more patient responses matching the parameter of the request; and
displaying, on a user interface display, using data surfacing logic, the aggregated one or more patient responses.

11. The method of claim 10, wherein the requesting entity is a provider.

12. The method of claim 10, wherein the requesting entity is a prospective patient.

13. The method of claim 10, wherein the requesting entity is a practitioner.

14. The method of claim 10, wherein the parameter is selected from the group consisting of: a specialty parameter, a physical parameter, and a personal parameter.

15. The method of claim 12, wherein displaying comprises displaying the aggregated one or more patient responses overlaid on a map, generated using map generator logic, based on an indication of a location associated with each of the one or more patient responses.

16. The method of claim 10, wherein the parameter is a first parameter, and wherein aggregating and displaying comprises aggregating and displaying the one or more patient responses based on a second parameter.

17. The method of claim 16, wherein the second parameter is a time of patient treatment.

18. The method of claim 10, wherein the parameter is a first parameter, and the method further comprises:
repeating the steps of searching a response index and aggregating the one or more patient responses in response to a second identified parameter.

19. A method of accumulating searchable verified patient response data, the method comprising:
receiving a patient response from a patient, using a response analyzer logic, the response comprising feedback about a procedure, wherein the feedback comprises an indication concerning a healthcare practitioner;
identifying the patient as a verified patient, using patient verification logic, based on the received patient response;
anonymizing patient data, using response anonymizer logic, within the received patient response; and
indexing the patient response by the indication, using a response indexing logic, such that the patient response is searchable by the indication.

20. The method of claim 19, wherein identifying the patient as a verified patient comprises patient verification logic comparing the received patient response to an indication of actual patient data provided from a healthcare provider.

21. The method of claim 20, wherein the healthcare provider is selected from a group consisting of: a practitioner, a healthcare facility and an insurance company.
